(19) United States
(12) Patent Application Publication
(10) Pub. No.: US 2004/0187367 A1
(43) Pub. Date: Sep. 30, 2004

(54) Combination calendar, count-down chart and growth chart

(76) Inventors: Susan Y. Davis, Amboy, WA (US); Lydia B. Dalrymple, Amboy, WA (US)

Correspondence Address: Susan Y. Davis, 718 Laurel Street, San Jose, CA, 95126, US

(21) Appl. No.: 10/817,301

(22) Filed: Apr. 2, 2004

Related U.S. Application Data
(63) Continuation of application No. 10/281,286, filed on Oct. 25, 2002.

(51) Int. Cl. G09D 3/00

(52) U.S. Cl. 40/107; 33/512

(57) ABSTRACT

A wall-hanging keepsake (10) made of a material having a first side (12) including a growth chart and a second side (30) that can be configured as either an interactive calendar, a count-down chart, or both. The first side (12) includes a measuring tape (14) that runs the substantial length of the keepsake (10), a marking surface (16) adjacent the measuring tape (14) for marking the height of a child on the growth chart, and foot numerals to indicate the foot markers on the measuring tape (14). The second side, when used as an interactive calendar, designates a month and a date. As a regular calendar, the keepsake (10) includes a plurality of pockets numbered 1-31 and a month holder (32) configured to hold a header card indicative of one of the months of the year. Additionally, the “Today Is” pocket card (56) is provided to mark the current date of the month. As a count-down chart, a holder is provided to hold a heading card (54) that is used to designate an event. A count-down pocket card (58) is then inserted into the appropriate numbered pocket to count down the days to the designated event. In various embodiments, the keepsake is made of fabric, cardboard, metal, wood or plastic and a dowel is used to hang it onto a wall surface.

### BACKGROUND OF THE INVENTION

1. Field of Invention

The present invention relates generally to a combination activity calendar, count-down chart and growth chart for children, and more particularly, to a wall-hanging fabric keepsake that has a growth chart for children on one side and a reusable activity calendar and/or an event count-down chart on the other side.

2. Description of the Related Art

Many families maintain a growth chart for their children on a wall, or a bedroom door, or other permanent surface. As a child grows and reaches a milestone, such as a birthday, the height of the child is marked on the growth chart. Over time, a chart that records the growth history of the child is created. One problem with such growth charts is that they are not permanent keepsakes. The family may move or the growth chart may be painted or otherwise covered as the child grows older and the room is redecorated.

Calendars are a popular teaching tool. For instance, young children (or adults with special needs) can be taught their numbers and ABC's as well as the months of the year, the days of the week, and the number of days per month. Most children are taught by using a basic, disposable, annual calendar.

Count-down calendars are also used by children to count the days to an event. For example, Advent calendars are most commonly known to help children “count down” the days to Christmas, December 25th. One problem with this type of calendar is that it is limited to only one holiday. They are typically disposable and made to be used only once.

A wall-hanging fabric keepsake that includes the combination of a growth chart for children on one side and an interactive activity calendar and an event count-down chart on the other side is therefore needed.

### SUMMARY OF THE INVENTION

The present invention relates to a wall-hanging keepsake made of a material having a first side including a growth chart and a second side that can be used as an interactive activity calendar and/or an event count-down chart. The first side includes a measuring tape that runs the substantial length of the keepsake, a marking surface adjacent the measuring tape for marking the height of a child on the growth chart, and numerals to indicate the foot markers on the measuring tape. The interactive activity calendar can be used as either a regular calendar that designates the days of a month and/or as an event count-down chart.

As a regular calendar, the keepsake includes a plurality of pockets numbered 1-31 and a month holder configured to hold a heading card indicative of one of the months of the year. Various pocket cards can also be placed in appropriate numbered pockets for appointment reminders, chores to do, etc.

As a count-down chart, the same or a different holder is used to hold a heading card to designate an event. A count-down pocket card labeled “Today Is” is inserted into the appropriate numbered pocket to count down the days to the designated event. In various embodiments, the keepsake is made of fabric, cardboard, metal, wood or plastic A dowel, hooks, fabric loops, a ribbon, string, or the like, all can be used to hang the keepsake onto a wall surface.

### BRIEF DESCRIPTION OF THE DRAWINGS

The invention may best be understood by reference to the following description taken in conjunction with the accompanying drawings in which:

FIG. 1 is diagram of a growth chart side of the keepsake of the present invention.

FIG. 2 is a diagram of a calendar and/or an event count-down side of the keepsake of the present invention.

FIG. 3 is a diagram of a number of different types of place cards that can be used with the keepsake of the present invention.

It should be noted that like numbers refer to like elements in the figures.

### DETAILED DESCRIPTION OF THE EMBODIMENTS

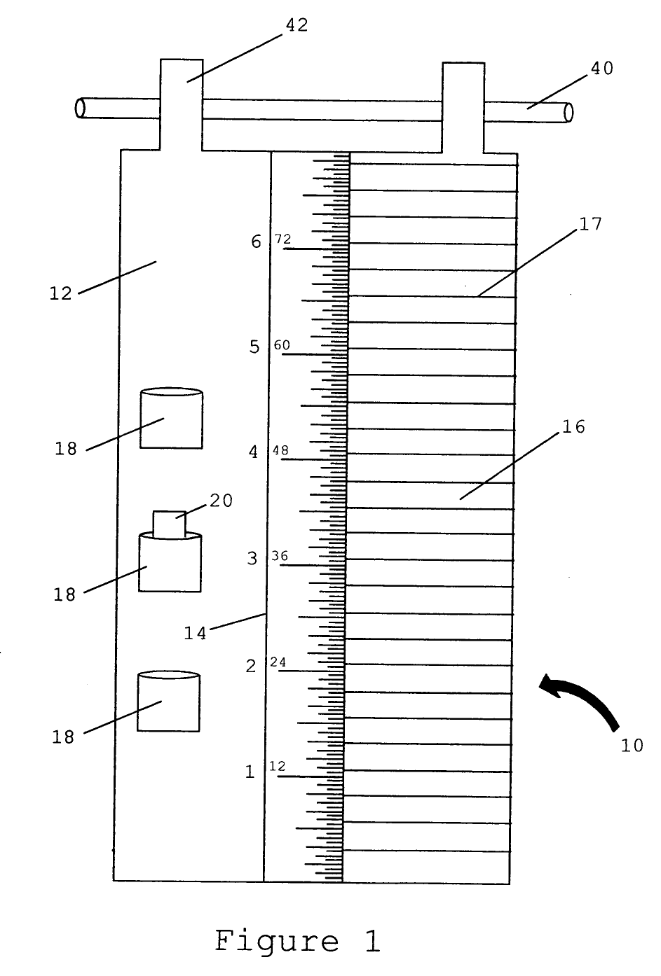

Referring to FIG. 1, a diagram of a first side including a growth chart of a keepsake of the present invention is shown. The keepsake 10 includes a first side 12 which defines a growth chart. The first side 12 includes a measuring tape 14 that runs the length of the keepsake 10. The measuring tape 14 provides inch markings 1″ through 72″ from bottom to top respectively. Also provided are foot markers 1″ through 6′ adjacent the measuring tape 14. A marking surface 16 including a plurality of lines 17 is provided adjacent the measuring tape 14 for marking the height of a child on the growth chart. A number of pockets 18 are also provided on the first side 12. The pockets 18 can be used for a variety of purposes, for example, storing a marking pen 20 as well as the heading and pocket cards (not shown). The measuring tape 14, according to various embodiments of the invention, is either sewn or glued onto the first side 12 of the keepsake 10. The pockets can be made of felt, clear plastic or of any other material and sewn, glued, or attached with Velcro® onto the first side 12 of the keepsake 10, according to various embodiments of the invention.

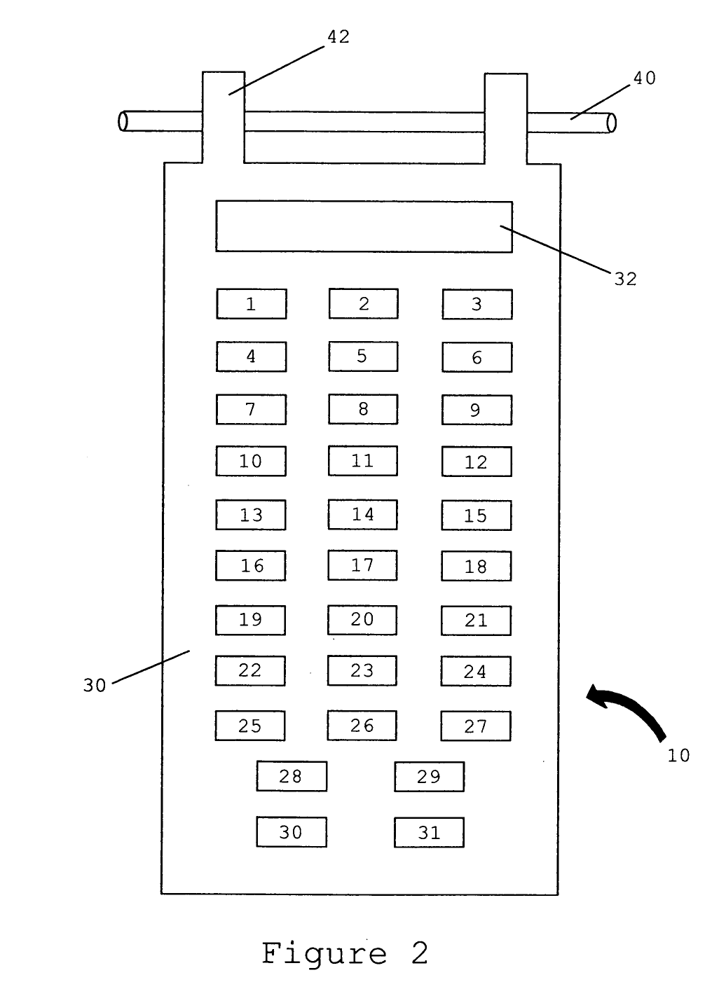

Referring to FIG. 2, a diagram of the second side of the keepsake 10 of the present invention is shown. The second side 30 is used as a calendar and/or an event count-down chart and includes a plurality of pockets numbered sequentially 1-31. The second side also includes a month/event holder 32. The holder 32 can be a clear pocket or a strip of Velcro® can be attached with glue or sewn to hold the heading cards, according to various embodiments of the invention.

As shown in FIGS. 1 and 2, a dowel 40 and loops 42 are provided at the top of the keepsake. Together, the dowel 40 and loops 42 provide a hanging unit configured to reversibly hang the keepsake 10 onto a surface, such as a wall. In one configuration, the first side 12 is visible when the keepsake is hanging on the surface. Alteratively, the second side 30 of the keepsake 10 is visible when hung in the reverse. In other embodiments, hooks, fabric loops, a ribbon, string, or the like, can be used to hang the keepsake onto a wall surface.

According to one embodiment, the keepsake is made of fabric. In alternative embodiments, the keepsake can be made of other materials such as plastic, cardboard, posterboard, wood or metal.

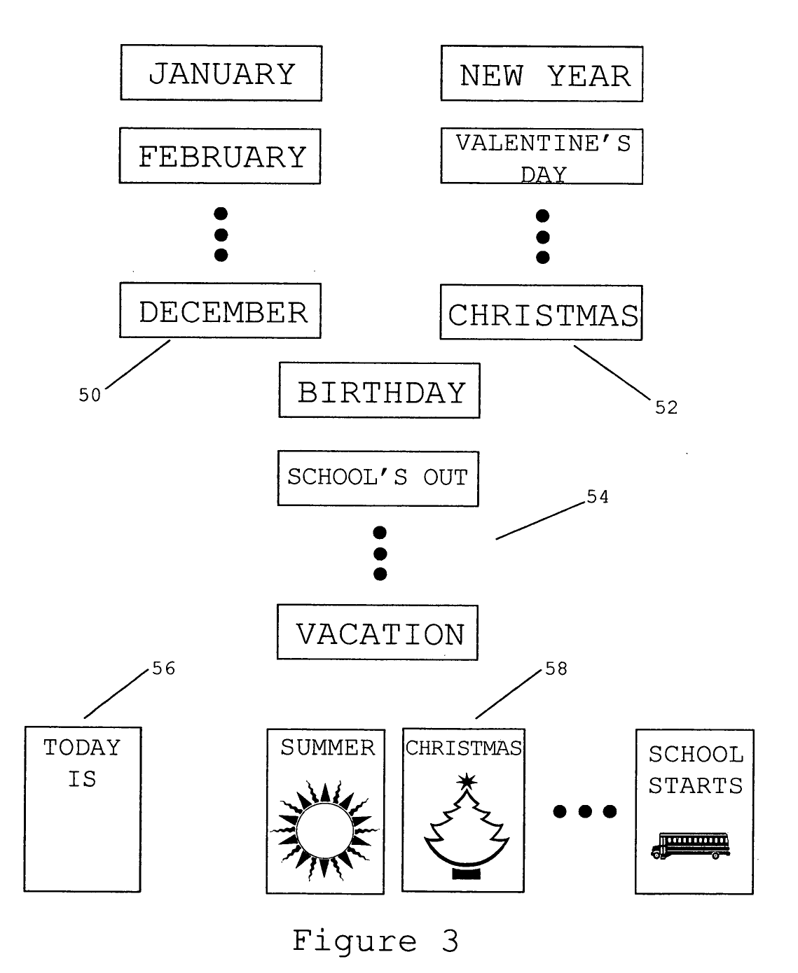

Referring to FIG. 3, a diagram of a number of different types of cards that may be used with the keepsake of the present invention is shown. A first set of heading cards 50 are used to list the months of the year. A second set of heading cards 52 are used to list the holidays of the year. A third set of heading cards 54 are provided for listing a variety of designated events or special occasions, such as “Birthday”, “Vacation”, “School's Out”, etc. A “Today Is” pocket card 56 is provided to designate the current day of the month when used with the regular calendar. A fourth set of pocket cards 58 are provided to illustrate and label a particular chore, appointment, holiday, event, season, or other notable occasion in its appropriate numbered pocket.

In various embodiments of the invention, the various cards may include, but are not limited to: birthday, winter, spring, summer, fall, New Year's, Valentine's day, Saint Patrick's day, Easter, Passover, President's day, Memorial day, the Fourth of July, Labor day, Columbus day, Halloween, Thanksgiving, Christmas, Hanukkah, Vacation, School's Out, School Starts, trash, practice, doctor, dentist, movies, haircut, etc., or any other holiday or special occasion. In various embodiments, the cards are made of laminated paper, cardboard, plastic, metal, wood, or any other suitable material. When cards are not in use, they may be stored in pockets 18 on the first side 12 of the keepsake.

According to various embodiments of the invention, the calendar can be used as either a regular calendar or as a count-down chart.

When used as a regular calendar, a month heading card 50 is placed in the month holder 32. To indicate the day of the month, the “Today Is” pocket card 56 is inserted in the appropriate numbered pocket 1-31. With the passage of each day, the “Today Is” card is moved to the next highest numbered pocket. With the passage of each month, the appropriate month card is placed in the month holder 32. Various pocket cards 58 may be used in any of the numbered pockets as a reminder of that day's event. For instance, if a doctor's appointment is scheduled for the 15th, the “doctor” pocket card is placed in the number 15 pocket as a reminder.

When used as an event count-down chart, a heading card that designates a special event or holiday is placed in the holder 32. A pocket card that appropriately describes the event is then placed in the appropriate numbered pocket that indicates the number of days until the event. With the passage of each day, the pocket card is moved to the next lowest numbered pocket. For example, when the numbered pockets are used as a count-down to the holiday, Christmas, the heading card labeled “Christmas” is placed in holder 32. On December 1, the Christmas pocket card is placed in pocket number twenty-five (25). With each passing day, the card is moved to the next lowest numbered pocket. Finally, after twenty-five days or on December 25, the card is moved into pocket number one (1), indicating that it is Christmas day. This count-down method can be used in a similar way for any holiday or special event or occasion.

Another example of this count-down method is to place the heading card labeled “Vacation” in holder 32 and place the vacation pocket card in pocket number ten (10) to represent that vacation starts in 10 days. Similar to the above example, the pocket card is moved each day to the next lowest numbered pocket. When the card reaches pocket number one (1), that is the day when vacation starts.

In the embodiment shown in FIG. 2, the pockets numbered 1-31 are used for either a calendar or an event-count chart. It should be noted, however, that in alternative embodiments, two header cards (i.e., a month and an event card) can be used so that the pockets 1-31 can be simultaneously used as a calendar and an event count-down chart or the second side can include two sets of pockets so the second side can have a separate calendar and an event count-down chart.

Although only a few embodiments of the present invention have been described, it should be understood that the present invention may be embodied in many other specific forms without departing from the spirit or the scope of the present invention. Therefore, the present examples are to be considered as illustrative and not restrictive, and the invention is not to be limited to the details given herein, but may be modified within the scope of the appended claims.

What is claimed is:

1. An apparatus, comprising:
a material having a first side and a second side,
the first side including a growth chart and
the second side being configurable to be an interactive calendar and/or an event count-down chart.

2. The apparatus of claim 1, wherein the material comprises one of the following materials: fabric, cardboard, plastic, posterboard, metal and wood.

3. The apparatus of claim 1, further comprising a hanging unit, coupled to the material, configured to reversibly hang the material on a surface such that either the first side or the second side of the material is visible while the material is hanging on the surface.

4. The apparatus of claim 3, wherein the hanging unit is one of the following a dowel, hooks, fabric loops, a ribbon, or string.

5. The apparatus of claim 1, wherein the material has a length of seven feet long or less.

6. The apparatus of claim 1, wherein the growth chart included on the first side of the material includes a measuring tape that runs the substantial length of the material.

7. The apparatus of claim 6, wherein the growth chart included on the first side of the material includes a marking surface adjacent the measuring tape for marking the height of a child on the growth chart.

8. The apparatus of claim 6, wherein the growth chart included on the first side of the material includes foot numerals indicating the foot markers on the measuring tape.

9. The apparatus of claim 6, wherein the growth chart included on the first side of the material includes one or more pockets configured to store heading and pocket cards.

10. The apparatus of claim 8, wherein the one or more card pockets comprises one of the following: pockets made of felt, clear plastic or any other material, and sewn, glued or attached with Velcro®.

11. The apparatus of claim 6, wherein the growth chart included on the first side of the material includes a pocket configured to hold a marking pen for marking the material.

12. The apparatus of claim 1, wherein the interactive calendar on the second side of the material includes a first plurality of pockets, each of the first plurality of pockets labeled with a number.

13. The apparatus of claim 12, wherein the first plurality of pockets are sequentially numbered from 1-31.

14. The apparatus of claim 13, further comprising a plurality of pocket cards configured to be inserted into any one of the plurality of pockets, the plurality of cards each indicative of a designated event or reminder.

15. The apparatus of claim 14, wherein the plurality of pocket cards are each indicative of one of the following events: birthday, winter, spring, summer, fall, new year, Valentine's day, Saint Patrick's day, Easter, Passover, President's day, Memorial day, the Fourth of July, Labor day, Columbus day, Halloween, Thanksgiving, Christmas, Hanukkah, vacation, school's out, school starts, trasn, practice, doctor, dentist, movies, haircut, etc., or any other holiday or special occasion.

16. The apparatus of claim 12, wherein the interactive calendar further comprises a month holder configured to hold a heading card indicative of one of the months of the year.

17. The apparatus of claim 14, wherein the plurality of cards includes a pocket card labeled “Today Is” indicative of the day of the month.

18. The apparatus of claim 1, wherein the interactive calendar becomes a count-down chart configured to enable a user to count down to a designated event.

19. The apparatus of 18, wherein the count-down chart includes a holder for selectively holding one of a plurality of cards that each identify a different designated event.

20. The apparatus of claim 19, wherein the plurality of cards includes heading cards for designating one or more of the following events: birthday, New Year's, Valentine's day, Saint Patrick's day, Easter, Passover, President's day, Memorial day, the Fourth of July, Labor day, Columbus day, Halloween, Thanksgiving, Christmas, Hanukkah, vacation, school's out, school starts, or any other holiday or special occasion.

21. The apparatus of claim 19, wherein the plurality of cards includes pocket cards for designating one or more of the following events: birthday, New Year's, Valentine's day, Saint Patrick's day, Easter, Passover, President's day, Memorial day, the Fourth of July, Labor day, Columbus day, Halloween, Thanksgiving, Christmas, Hanukkah, vacation, school's out, school starts, or any other holiday or special occasion.

22. The apparatus of claim 19, further comprising a pocket card that is used to count down to the designated event.

23. The apparatus of claim 22, wherein the pocket card is configured to be sequentially inserted into placed into a plurality of sequentially numbered pockets to count-down the days until the designated event.

24. A method, comprising:
forming a growth chart on one side of a material, the growth chart including a tape measure configured to measure the height of a child; and
forming a calendar and/or event count-down chart on a second side of the material.

25. The method of claim 24, further comprising attaching the tape measure to the first side of the material by using one of the following attachment mechanisms: sewing, Velcro®, gluing, printing, or painting.

26. The method of claim 24, further comprising forming a marking surface adjacent the tape measure to mark the height of a child on the first surface.

27. The method of claim 24, further comprising forming a number of foot-markers on the first surface.

28. The method of claim 24, further comprising forming one or more pockets on the first surface.

29. The method of claim 24, further comprising forming a holder to hold a header card.

30. The method of claim 29, wherein the header card is used to designate a month of the year.

31. The method of claim 29, wherein the header card is used to designate an event.

32. The method of claim 24, further comprising forming a plurality of sequentially numbered pockets on the second surface, wherein the sequentially numbered pockets are used to designate the day of a month when the second side is configured as a calendar.

33. The method of claim 24, further comprising forming a plurality of sequentially numbered pockets on the second surface, wherein the sequentially numbered pockets are used to count-down the days to a designated event when the second side is configured as the count-down chart.

34. The method of claim 24, further comprising the formation of a plurality of cards, each of the cards being indicative of, but not limited to, the following: a “Today Is”, birthday, New Year's, Valentine's day, Saint Patrick's day, Easter, Passover, President's day, Memorial day, the Fourth of July, Labor day, Columbus day, Halloween, Thanksgiving, Christmas, Hanukkah, vacation, school's out, school starts, or any other holiday or special occasion.

35. The method of claim 34, wherein the plurality of cards are made from one of the following: laminated cards, plastic, wood, posterboard, or metal.

36. The method of claim 24, wherein the material is made of one of the following: fabric, cardboard, plastic, or wood.

37. The method of claim 24, further comprising forming a hanging device, attached to the material, for hanging the material on a surface such that either the first side or the second side of the material is exposed.
